(19) United States
(12) Patent Application Publication
(10) Pub. No.: US 2016/0004824 A1
(43) Pub. Date: Jan. 7, 2016

(54) Method, Apparatus, And Computer Program Product For Providing Prioritization Of Subunits In A Geospatial Arrangement

(71) Applicant: McKesson Corporation, San Francisco, CA (US)

(72) Inventors: John Stanton, Hoover, AL (US); Rodney Blake Driskill, Trussville, AL (US); Bryan Self, Birmingham, AL (US); Rocco Joseph Plaia, Birmingham, AL (US); Kevin Johnson, Hoover, AL (US)

(21) Appl. No.: 14/324,429

(22) Filed: Jul. 7, 2014

(51) Int. Cl. G06F 19/00; G06Q 10/10; G06Q 50/22

(52) U.S. Cl. CPC G06F 19/327; G06Q 50/22; G06Q 10/10

(57) ABSTRACT

A method, computer program product, and apparatus is provided for providing prioritization of subunits. Visual indications of the prioritization may be displayed on interfaces such as geospatial arrangement. Medical facilities may utilize embodiments to indicate priorities of rooms to which to admit incoming patients. Users and staff within a particular unit may therefore prioritize subunits according to the unit's needs. Users in bed management, which may operate remotely from the unit, may easily identify high priority rooms to which to admit incoming patients. Priorities of subunits may be reassigned accordingly as prioritized subunits are utilized, and as other subunits are newly prioritized.

### TECHNOLOGICAL FIELD

Embodiments of the present invention relate generally to computer technology and, more particularly, to methods, apparatuses, and computer program products for providing prioritization of subunits in a geospatial arrangement.

### BACKGROUND

The widespread use of modern computing technology and improvements in visual media has led to an increasing demand for visual representations of data. The healthcare industry, among others, is one that utilizes geospatial arrangements to convey information in a visual format, efficiently and effectively to various units and individuals, such as throughout a hospital, for example. Doctors and staff may view a floor plan of patient rooms for a particular floor of a hospital to manage workflows and attend to patients. In some examples, extensive amounts of data relating to patients, staff, and practice groups, among others, may result in the display of an overwhelming amount of information.

### BRIEF SUMMARY OF SOME EXAMPLE EMBODIMENTS

Methods, apparatuses, and computer program products are therefore provided for providing prioritization of subunits in a geospatial arrangement. According to example embodiments, nurses or other hospital staff may indicate which rooms in a hospital unit or floor are highest or higher priority rooms to fill. The prioritizations may be visually indicated on a geospatial arrangement, allowing other users, such as those working in bed management, to easily identify a next room to which to admit or assign a new or incoming patient. As rooms are filled, the prioritization of rooms may be adjusted accordingly.

A method is provided including receiving an indication of a priority of at least one subunit in a unit, wherein the unit and subunits are defined based on a physical location, based on the indication of the priority, assigning the priority to the subunit in a memory of an apparatus, with processing circuitry, determining at least a current highest prioritized subunit of the unit, causing provision of a visual indication of the current highest prioritized subunit in the unit, receiving an indication that the at least one subunit is utilized, and in response to receiving the indication that the at least one subunit is utilized, unassigning the priority from the subunit in the memory of the apparatus.

In some embodiments, the method further includes, causing provision of the visual indication of the current highest prioritized subunit in the unit comprises causing display of a geospatial arrangement comprising a visual representation of a plurality of subunits in the unit, and causing display of the visual indication on the geospatial arrangement and in association with the visual representation of the current highest priority subunit. In some embodiments, causing provision of the visual indication of the current highest prioritized subunit in the unit comprises causing display of a selectable list of at least two subunits in the unit, and causing display of the visual indication of the highest priority in association with the highest priority subunit.

The method may further include reassigning a next highest priority subunit to become the highest priority subunit. In some embodiments, the indication of the priority of the at least one subunit is provided via a first device and the indication to utilize the at least one subunit is provided via a second device. The method may further include receiving an additional indication, the additional indication indicating a higher priority subunit than at least one currently prioritized subunit, and in response to receiving the additional indication, reprioritizing the at least one currently prioritized subunit and prioritizing the higher priority subunit.

A computer program product is provided including at least one non-transitory computer-readable medium having computer-readable program instructions stored therein, the computer-readable program instructions comprising instructions, which when performed by an apparatus, are configured to cause the apparatus to perform at least receiving an indication of a priority of at least one subunit in a unit, wherein the unit and subunits are defined based on a physical location, based on the indication of the priority, assigning the priority to the subunit in a memory of an apparatus, determining at least a current highest prioritized subunit of the unit, causing provision of a visual indication of the current highest prioritized subunit in the unit, receiving an indication that the at least one subunit is utilized, and in response to receiving the indication that the at least one subunit is utilized, unassigning the priority from the subunit in the memory of the apparatus.

An apparatus is provided including processing circuitry configured to cause the apparatus to perform at least receiving an indication of a priority of at least one subunit in a unit, wherein the unit and subunits are defined based on a physical location, based on the indication of the priority, assigning the priority to the subunit in a memory of an apparatus, determining at least a current highest prioritized subunit of the unit, causing provision of a visual indication of the current highest prioritized subunit in the unit, receiving an indication that the at least one subunit is utilized, and in response to receiving the indication that the at least one subunit is utilized, unassigning the priority from the subunit in the memory of the apparatus.

An apparatus is provided including means for receiving an indication of a priority of at least one subunit in a unit, wherein the unit and subunits are defined based on a physical location, means for, based on the indication of the priority, assigning the priority to the subunit in a memory of an apparatus, means for determining at least a current highest prioritized subunit of the unit, means for causing provision of a visual indication of the current highest prioritized subunit in the unit, means for receiving an indication that the at least one subunit is utilized, and means for, in response to receiving the indication that the at least one subunit is utilized, unassigning the priority from the subunit in the memory of the apparatus.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is an example geospatial arrangement;

FIG. 2 is a block diagram of a system for providing prioritization of subunits according to some example embodiments;

FIG. 3 is a block diagram of an apparatus for providing prioritization of subunits according to some example embodiments;

FIG. 4A is a flowchart of operations for providing prioritization of subunits according to some example embodiments;

FIG. 4B is a flowchart of operations for maintaining prioritization of subunits according to some example embodiments;

FIG. 5 is an example display for providing prioritization of subunits according to some example embodiments;

FIG. 6 is an example geospatial arrangement providing visual indications of prioritization of subunits according to some example embodiments; and

FIGS. 7 and 8 are example interfaces providing visual indications of prioritization of subunits according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described to receive data from another computing device, it will be appreciated that the data may be received directly from the other computing device and/or may be received indirectly via one or more intermediary computing devices, such as, for example, one or more servers, relays, routers, network access points, and/or the like. Similarly, where a computing device is described herein to transmit data to another computing device, it will be appreciated that the data may be sent directly to the other computing device or may be sent to the other computing device via one or more interlinking computing devices, such as, for example, one or more servers, relays, routers, network access points, and/or the like.

### Overview

Methods, apparatuses, and computer program products are provided for providing prioritization of subunits in a geospatial arrangement.

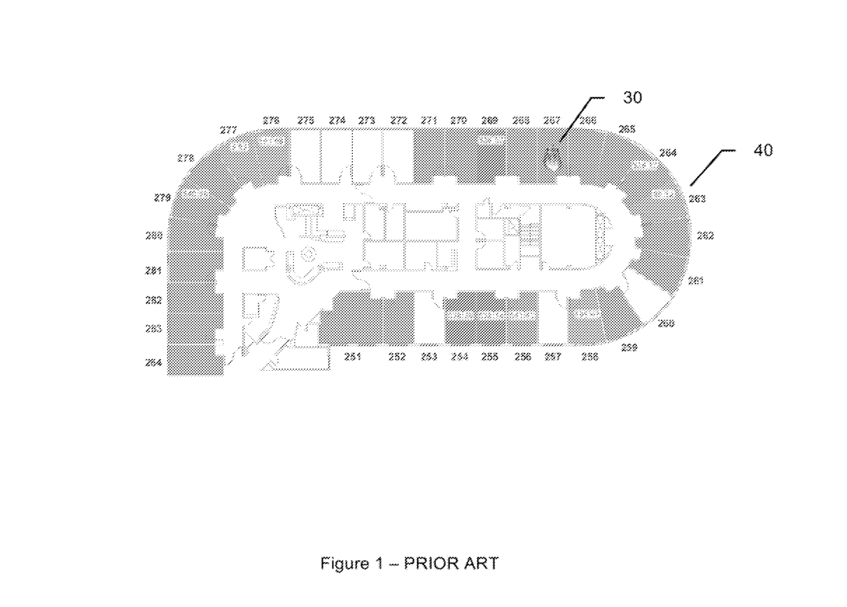

FIG. 1 illustrates a geospatial arrangement of a hospital floor. The geospatial arrangement provides information for the entire floor by room. Some rooms are color coded to provide statuses of rooms or patients in them. For example, for a cleaning crew, the geospatial arrangement may show color coded rooms to indicate which rooms are cleaned and which rooms are in need of cleaning. As an alternative use, the rooms may be color coded to indicate which rooms are occupied or vacant. Further, icon 30 indicates that an alarm has signaled in room 267, and timer 40 on room 263 indicates a countdown until a specified event or an elapsed time since a previously occurring event. The example geospatial arrangement may therefore provide pertinent information related to an entire floor or unit of the hospital in a visual format easily interpreted by a user.

In some examples, nurses may have preferences regarding which vacant rooms are next filled by patients. A bed management group, working independently and possibly remotely from a clinical unit or hospital floor may make assumptions based on information provided on the geospatial arrangement. Users may have to study the geospatial arrangement to determine a suitable room to which to admit a patient. In some examples, newly admitted patients may be assigned to rooms less convenient to the nurses and staff working in the unit, due to location, staff assignments, and/or the like. Because bed management may work independently and/or remotely from a particular clinical unit, bed management may not have access to pertinent or up to date information that should be considered during patient room assignments. Attempts by nurses to indicate on a geospatial arrangement the preferred rooms to utilize would require the nurse to make continual updates to the system throughout the day and in response to a changing fast pace work environment, which may not be feasible. Messages left for staff members regarding available rooms to be filled may not be received in time or by the appropriate staff member such that current information is timely disseminated to appropriate staff. Inconsistencies in data disseminated to various staff and/or units may lead to confusion and miscommunication regarding room availability and preferred bed assignment.

According to example embodiments, a user such as a nurse or other staff working in a particular unit may indicate via a workstation or other device the prioritization of any number of rooms, including rooms that are not yet available but may be known to become available in the near future. As the highest or higher priority rooms are utilized, the assigned priorities may automatically shift without further user interaction. Users in bed management may therefore access the system to easily and quickly determine the next room to which to admit an incoming patient, and may effectively manage bed assignment for a high volume of clinical units in large hospital environments.

Although a hospital is used throughout as an example embodiment, it will be appreciated that the embodiments provided herein may be beneficial in many other fields and uses. The hospital environment is cited as a non-limiting example, and should not be construed to narrow the scope or spirit of the disclosure in any way. Furthermore, while a nurse is commonly referred to as a user who provides the prioritization of subunits, and bed management as the group of users who access the prioritization of subunits, any other users or groups of users may use such embodiments as described herein.

### Example Embodiments

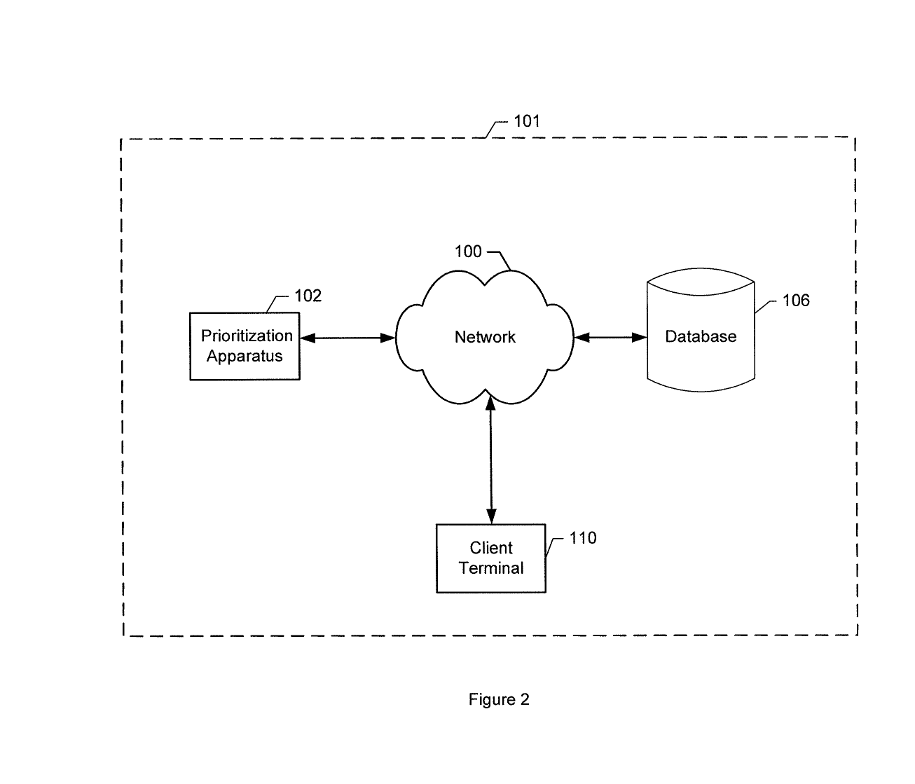

FIG. 2 illustrates a system 101 for providing prioritization of subunits according to some example embodiments. It will be appreciated that the system 101, as well as the illustrations in other figures, are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 2 illustrates one example of a configuration of a system, numerous other configurations may also be used to implement embodiments of the present invention.

The system 101 may include a network 100, prioritization apparatus 102, database 106, and/or a client, such as a client terminal 110. In some example embodiments, prioritization apparatus 102 may be embodied as or comprise one or more computing devices. In some example embodiments, prioritization apparatus 102 may be implemented as a distributed system or a cloud based entity that may be implemented within network 100. In this regard, prioritization apparatus 102 may comprise one or more servers, a server cluster, one or more network nodes, a cloud computing infrastructure, some combination thereof, or the like. The prioritization apparatus 102 may be a specialized computing device configured to carryout bed management processes in a hospital or other medical facility.

Prioritization apparatus 102 may be configured to manage priorities of subunits within a particular unit. Each subunit may be defined based on a physical location within a unit (e.g., a room on a floor of a building, address, or other geographical location). The priority of a subunit may therefore be relative to priorities of other subunits within the same unit. Inputs regarding priorities may be provided via client terminal 110 and stored and maintained by the prioritization apparatus 102, such as with database 106. Prioritization apparatus 102 may provide information, such as visual indications on geospatial arrangements, regarding current priorities of subunits. The information may be provided via web interface, for example, on client terminal 110.

The prioritization apparatus 102 may be configured to maintain prioritizations on database 106 by communicating over network 100, for example. The database 106 may be embodied as or comprise one or more computing devices configured to store data and provide data upon request to components of system 101. In example embodiments provided herein, the database 106 may be operative to store information associated with the infrastructure of a medical facility (e.g., hospital). For example, the database 106 may be used to systematically manage any information such as patient statuses, physician shift schedules, and/or nurse assignments, among others. The database 106 may be configured to receive data from any apparatus of the system 101 and/or external from system 101, such as from a third party system. The database 106 may operate independently from prioritization apparatus 102 and/or under different ownership than that of the prioritization apparatus 102, but it will be appreciated that in some embodiments, the database 106 may indeed be operated, separately, but nonetheless by the same entity in control of the prioritization apparatus 102.

Although FIG. 2 depicts one database 106, in some embodiments, any number of databases 106 may be present. In example embodiments provided herein, database 106 may be configured to operate under control of a database management system (DBMS). In some examples, database 106 may be configured to provide data to various servers and/or subsystems of the system 101. The data stored by database 106 may include room assignment data, priority information (e.g., any data or information relating to the prioritizations of subunits), and/or any other information displayed on a geospatial arrangement.

A client terminal 110 may be embodied as a user terminal such as a laptop computer, tablet computer, mobile phone, desktop computer, workstation, or other like computing device. The client terminal 110 may be remote from the prioritization apparatus 102 and/or database 106, in which case the client terminal 110 may communicate with any of the respective apparatuses via network 100. Additionally or alternatively, a client terminal 110 may be implemented on a prioritization apparatus 102. Client terminal 110 may be used to access an application provided by the prioritization apparatus 102, such as to provide inputs regarding prioritization of subunits, and/or to access priority information. As such, in example embodiments, physicians, staff, and/or other individuals may use client terminal 110 to provide and/or access priority information. In some examples, priority information may be provided to the prioritization apparatus 102 by one client terminal 110, and displayed on another client terminal 110. Any number of client terminals 110 may be present in system 101.

Network 100 may be embodied in a local area network, the Internet, any other form of a network, or in any combination thereof, including proprietary private and semi-private networks and public networks. The network 100 may comprise a wired network, wireless network (e.g., a cellular network, wireless local area network, wireless wide area network, some combination thereof, or the like), or a combination thereof, and in some example embodiments comprises at least a portion of the Internet.

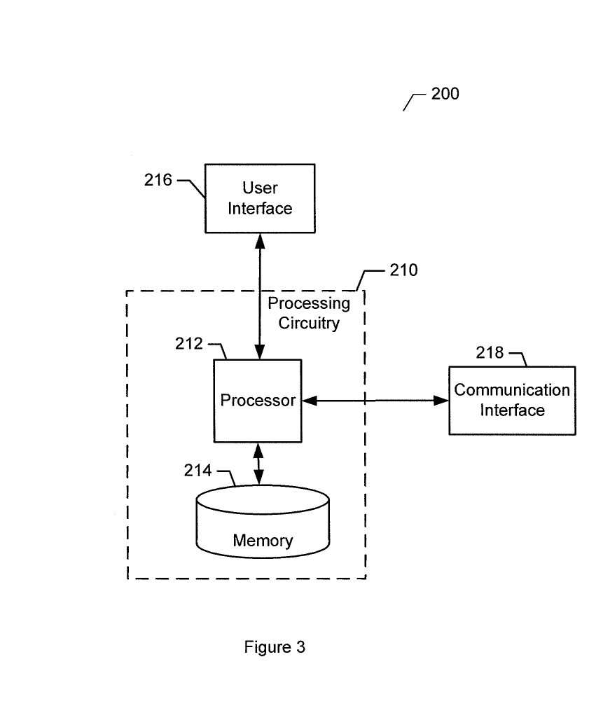

FIG. 3 illustrates an example apparatus 200 that may implement prioritization apparatus 102, and/or client terminal 110, in accordance with some example embodiments. However, it should be noted that the components, devices, and elements illustrated in and described with respect to FIG. 3 below may not be mandatory and thus some may be omitted in certain embodiments. For example, FIG. 3 illustrates a user interface 216, as described in more detail below, which may be provided by the client terminal 110, but may be optional in the prioritization apparatus 102. Additionally, some embodiments may include further or different components, devices, or elements beyond those illustrated in and described with respect to FIG. 3.

Continuing with FIG. 3, processing circuitry 210 may be configured to perform actions in accordance with one or more example embodiments disclosed herein. In this regard, the processing circuitry 210 may be configured to perform and/or control performance of one or more functionalities of prioritization apparatus 102, and/or client terminal 110 in accordance with various example embodiments. The processing circuitry 210 may be configured to perform data processing, application execution, and/or other processing and management services according to one or more example embodiments. In some embodiments, prioritization apparatus 102, and/or client terminal 110, or a portion(s) or component(s) thereof, such as the processing circuitry 210, may be embodied as or comprise a computing device, e.g., an integrated circuit or other circuitry. The circuitry may constitute means for performing one or more operations for providing the functionalities described herein.

In some example embodiments, the processing circuitry 210 may include a processor 212, and in some embodiments, such as that illustrated in FIG. 3, may further include memory 214. The processing circuitry 210 may be in communication with or otherwise control a user interface 216, and/or a communication interface 218. As such, the processing circuitry 210 may be embodied as a circuit chip (e.g., an integrated circuit) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform in one or more functionalities of prioritization apparatus 102, and/or client terminal 110 as described herein. The plurality of processors may be embodied on a single computing device or distributed across a plurality of computing devices collectively configured to function as prioritization apparatus 102, and/or client terminal 110. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as prioritization apparatus 102, and/or client terminal 110. The memory 214 may be configured to store information, data, applications, instructions and/or the like for enabling prioritization apparatus 102, and/or client terminal 110 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. For example, when apparatus 200 is implemented as prioritization apparatus 102, the memory 214 may be configured to store priority information. Among the contents of the memory 214, applications may be stored for execution by the processor 212 to carry out the functionality associated with each respective application. In some cases, the memory 214 may be in communication with one or more of the processor 212, user interface 216, and/or communication interface 218, for passing information among components of prioritization apparatus 102, third party system, and/or client terminal 110.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of managing or processing data access operations and/or the like. For example, in instances apparatus 200 is implemented as a client terminal 110, a user may provide priority information via the user interface 216. The user interface 216 may additionally or alternatively display a geospatial arrangement including visual indications of the priority information.

In some example embodiments in which prioritization apparatus 102 is embodied as a server, cloud computing system, or the like, aspects of user interface 216 may be limited or the user interface 216 may not be present. Accordingly, regardless of implementation, the user interface 216 may provide input and output means in accordance with one or more example embodiments, such as receiving and providing priority information.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable communication among prioritization apparatus 102, database 106, and/or client terminal 110 via network 100. Accordingly, the communication interface 218 may, for example, include supporting hardware and/or software for enabling wireless and/or wired communications via cable, digital subscriber line (DSL), universal serial bus (USB), Ethernet, or other methods.

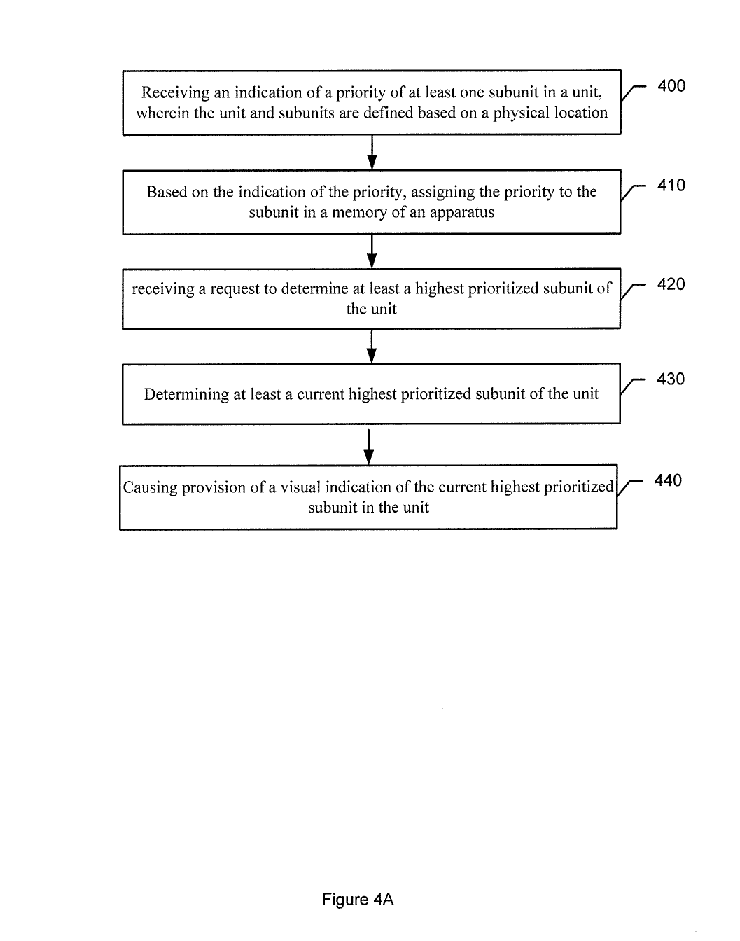

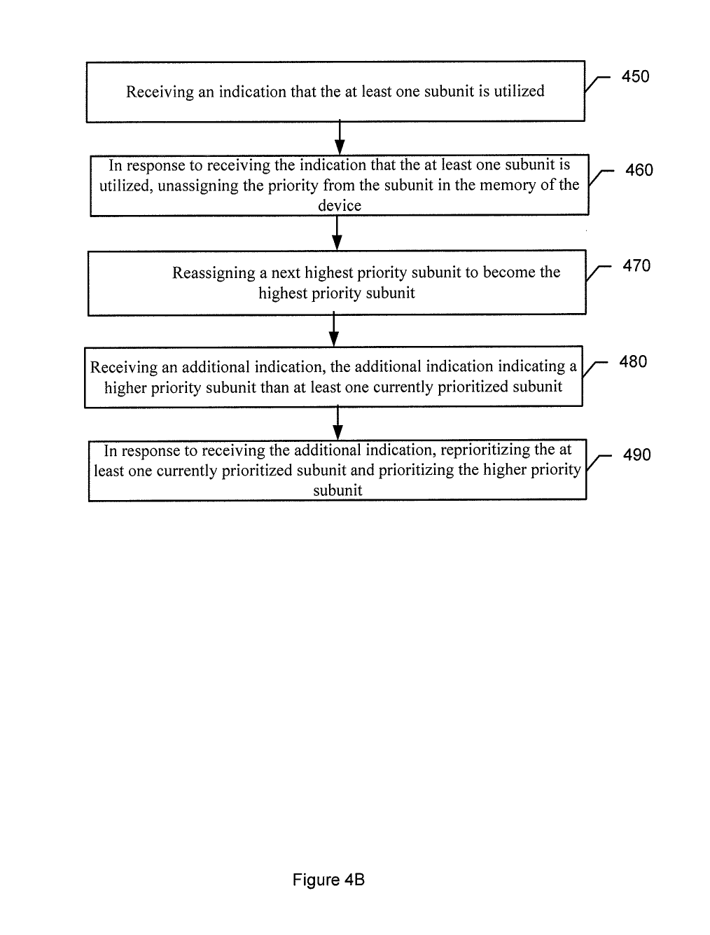

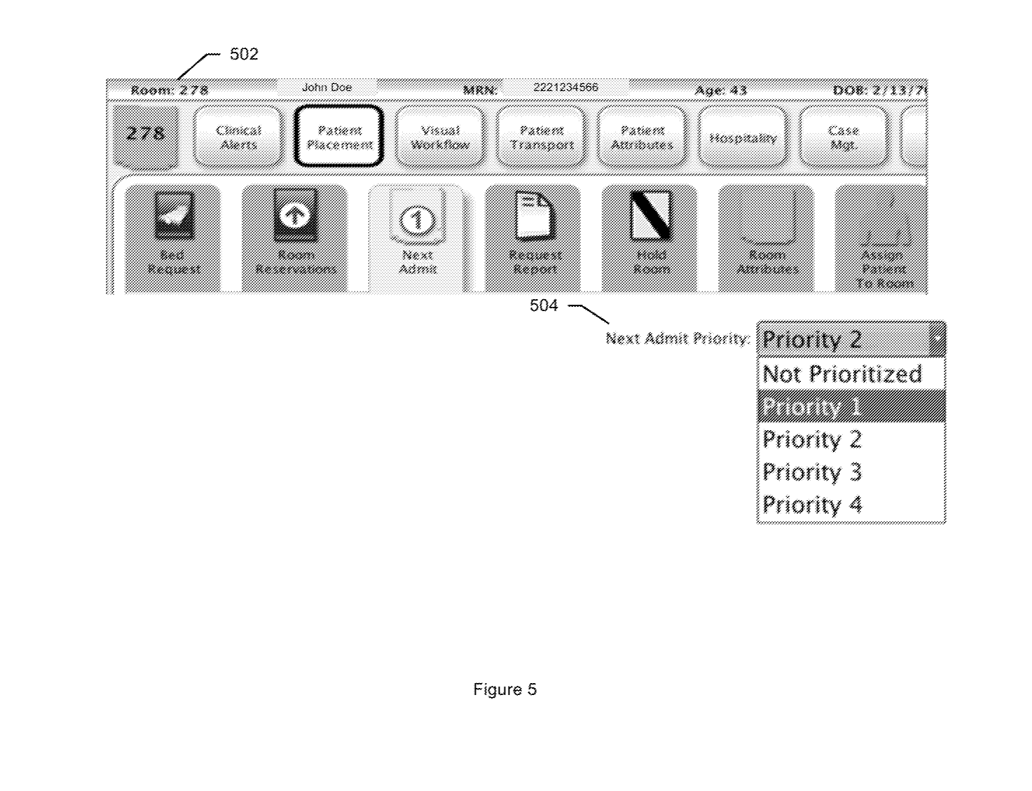

FIG. 4A is a flowchart illustrating example operations of prioritization apparatus 102 according to an example embodiment. As shown by operation 400, the prioritization apparatus 102 may include means, such as user interface 216, communication interface 218, processing circuitry 210, processor 212, and/or the like, for receiving an indication of a priority of at least one subunit in a unit, wherein the unit and subunits are defined based on a physical location. For example, a user such as a nurse working in a particular unit may view a geospatial arrangement, such as the example geospatial arrangement of FIG. 1. Upon selection of a particular subunit (e.g., room), a user interface such as the display of FIG. 5 may be provided. As shown by indicator 502, a current subunit (e.g., room 278) is selected. As shown by indicator 504, a user may provide the indication of the priority to assign to the selected subunit. In this example, priorities 1, 2, 3, 4, may be assigned, where 1 is the highest priority and 4 is the lowest priority. Any number of priorities may be assigned, and in some examples, alternative priorities may be assigned, such as high, medium, and low, for example. As the example user interface of FIG. 5 relates to patient assignment to rooms, the user interface indicates that the priority is a “Next Admit Priority.”

While the user interface of FIG. 5 allows a user to choose a subunit to which to prioritize, other types of indications may be received by the prioritization apparatus 102. For example, information regarding occurring events or other data made available to the database 106, for example, may trigger prioritization or reprioritization of subunits. For example, a system comprising staffing data may indicate a shift change in nurses in a particular unit. Based on the staffing assignments, a room may be prioritized accordingly, such as by geographical location in relation to a nurse station for example. The automatic prioritization may help ensure that the rooms closest to the nurse station are occupied first as opposed to rooms further away. As another example, an alert indicating a facilities issue in a particular room may lead to the priority of that room being removed or reprioritized lower, as a nurse would not want a new patient admitted to a room undergoing maintenance or repairs. The automatic indications generated by such processes may therefore supersede the manual assignment of priorities by nurses working in the unit.

As shown by operation 410, the prioritization apparatus 102 may include means, such as communication interface 218, processing circuitry 210, processor 212, memory 214, and/or the like, for, based on the indication of the priority, assigning the priority to the subunit in a memory of an apparatus, such as memory 214. As described above, data regarding any of the subunits may be stored in memory 214 and/or database 106. In response to receiving the indication as provided by a user or another process, the priority may be stored in association with the subunit so that the priority information may be maintained by the prioritization apparatus 102, and accessed via various client terminals 110, as described herein.

As shown by operation 420, the prioritization apparatus 102 may include means, such as user interface 216, communication interface 218, processing circuitry 210, processor 212, and/or the like, for receiving a request to determine at least a highest prioritized subunit of the unit. For example, a user in bed management may access an interface to determine to which room to admit an incoming patient. Such a request may in turn result in an initiation of a request to the prioritization apparatus 102 to provide priority information for display.

As shown by operation 430, the prioritization apparatus 102 may include means, such as user interface 216, communication interface 218, processing circuitry 210, processor 212, and/or the like, for determining at least a current highest prioritized subunit of the unit. For example, the prioritization apparatus 102 may retrieve from database 106 and/or from memory 214, priority information for a particular unit. In this regard, the prioritization apparatus 102 may determine the current highest prioritized subunit, any number of prioritized subunits, or all prioritized subunits.

As shown by operation 440, the prioritization apparatus 102 may include means, such as user interface 216, communication interface 218, processing circuitry 210, processor 212, and/or the like, for causing provision of a visual indication of the current highest prioritized subunit in the unit. In some embodiments, all prioritized subunits may be visually indicated. In some example embodiments, a subset of prioritized subunits may be visually indicated, such as a top 3 highest prioritized subunits.

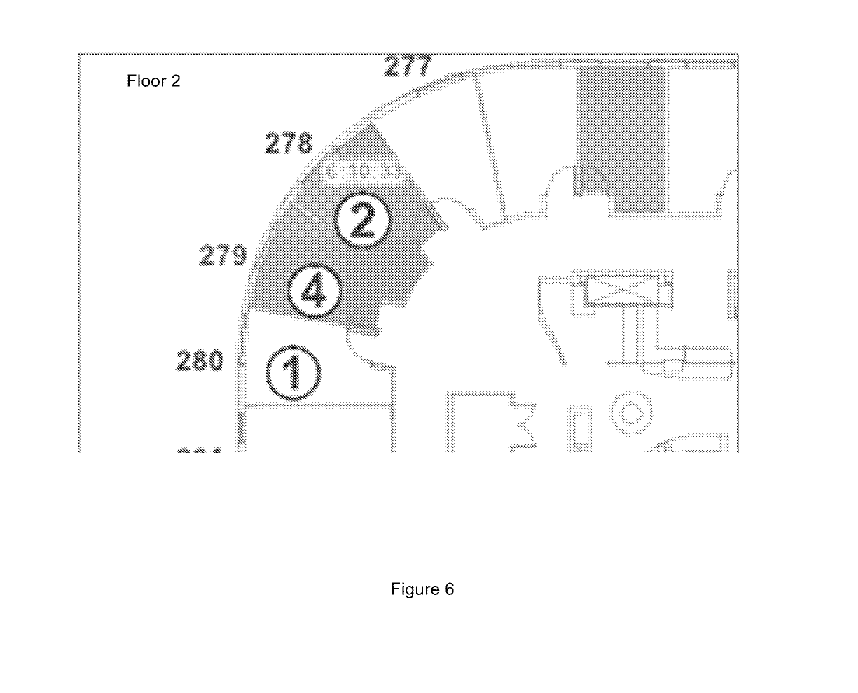

For example, in FIG. 6, a geospatial arrangement is provided. In this regard, causing provision of the visual indication may include causing display of a geospatial arrangement comprising a visual representation of a plurality of subunits in the unit, and causing display of the visual indication on the geospatial arrangement and in association with the visual representation of the highest priority subunit. In FIG. 6, the unit may be considered all of floor 2, or some portion of floor 2 as visually represented by the geospatial arrangement. In this example, room 280 is the highest priority subunit, as shown by the “1,” room 278 is the second next highest priority subunit, and room 279 is the 4th highest priority room. As the example illustrates, there may be gaps in assigned priorities, due to multiple users prioritizing subunits, a new patient assignment to a subunit other than the highest ranked subunit, or a previously prioritized subunit being deprioritized, or being assigned to a room not in view on the geospatial arrangement, for example. In some examples, a routine process may be performed by the prioritization apparatus 102, such as hourly, to remove the gaps in the ranked priorities, by reassigning lower priorities accordingly. For example, in an instance in which the prioritization apparatus 102 analyzes currently prioritized subunits for a particular unit and identifies a priority of 1, 2, and 4, the prioritization apparatus 102 may reassign the 4th ranked subunit to have a priority of 3.

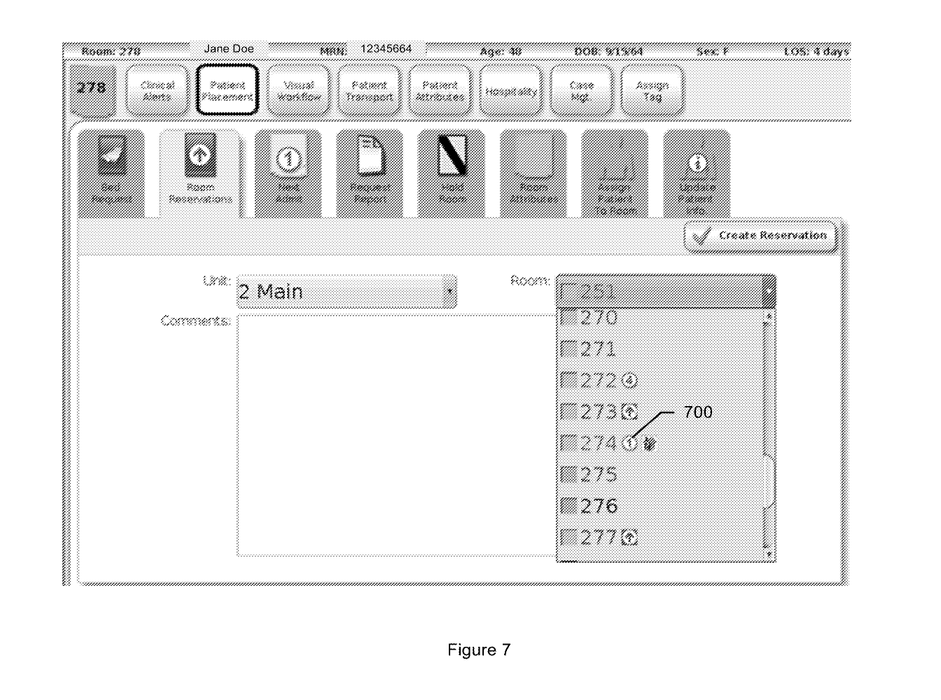

As an additional example of a visual indication of the current highest prioritized subunit, FIG. 7 may be used by a user in bed management while assigning an incoming patient to a room. In this example, providing the visual indication may include causing display of a selectable list of at least two subunits in the unit to which the user in bed management may assign a patient (e.g., rooms 251, 270, etc.), and causing display of the visual indication of at least the highest priority in association with the highest priority subunit. After providing patient information, or otherwise selecting a patient and appropriate unit to which to admit the patient, the display may provide the subunits belonging to the indicated unit, and in some embodiments, respective priorities for admission. For example, a user may easily identify the priority “1” at indicator 700 appearing next to room 274, and assign the incoming patient to the room by making the selection.

In some embodiments, a user of the user interface of FIG. 7 may either intentionally assign a patient to a low prioritized or non-prioritized room instead of the highest priority room. As such, the prioritization apparatus 102, may in some examples, warn the user when requesting such an assignment that another higher prioritized room is available, thus encouraging the rooms to be filled as requested by nurses and other staff working in the particular unit.

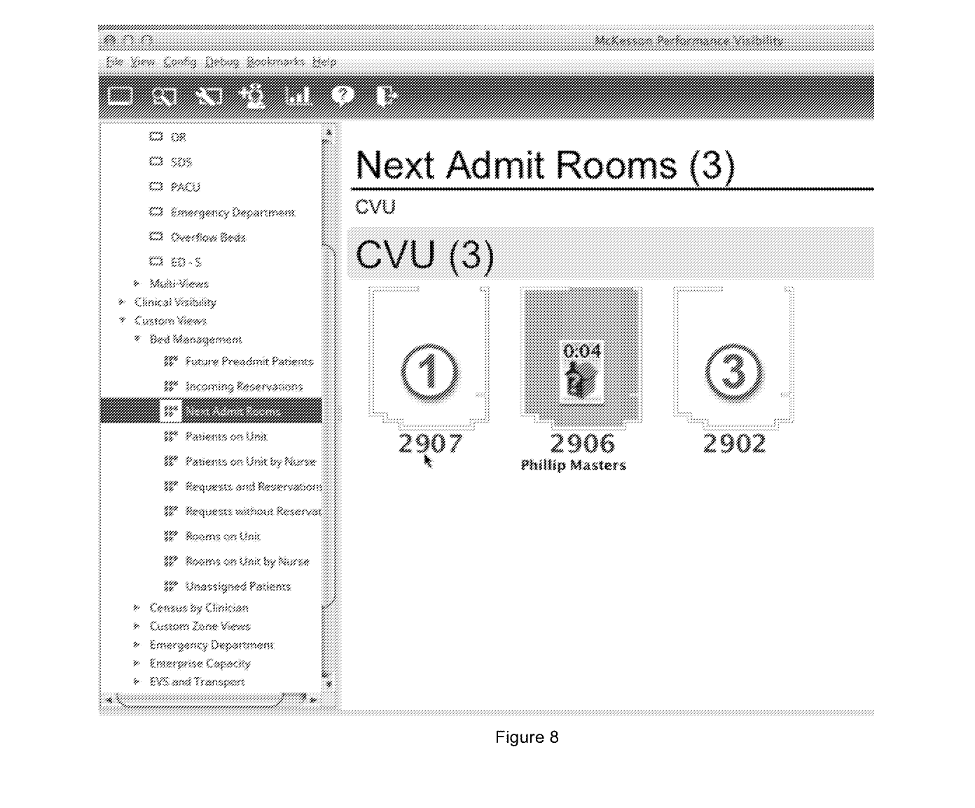

As yet another example, FIG. 8 is a logical view of prioritized subunits in a cardiovascular unit (CVU). In this example, the subunits are displayed without respect to their geographic locations within the unit, but rather filtered to display subunits within a particular unit that are prioritized. For example, room 2907 is assigned a priority 1, which may be the highest priority. Although the numerical indication of the priority of room 2906 is not shown, the priority may be may inferred by the ordering of the subunits on the display such that room 2906 is the next highest prioritized room after 2907. Room 2902 is prioritized third. As such, the display of FIG. 8 is another example of a visual indication of a priority of subunits. A user may access such a display to quickly determine the next room to which to admit an incoming patient.

FIG. 4B illustrates operations of the prioritization apparatus 102 for maintaining the priority of subunits, according to example embodiments. As shown by operation 450, the prioritization apparatus 102 may include means, such as user interface 216, communication interface 218, processing circuitry 210, processor 212, and/or the like, for receiving an indication that the at least one subunit is utilized. For example, a user from bed management may assign an incoming patient to a room, such as the highest prioritized room. The user may use a user interface such as provided in FIG. 7, for example. Once a patient is assigned to a prioritized room, the prioritization apparatus 102 may receive an indication that the subunit is utilized.

In response to receiving the indication that the at least one subunit is utilized, as shown by operation 460, the prioritization apparatus 102 may include means, such as communication interface 218, processing circuitry 210, processor 212, and/or the like, for unassigning the priority from the subunit in the memory of the device. The result may be that the utilized subunit is no longer prioritized so that other users do not inadvertently assign another patient to the room. Embodiments provided herein may benefit from the automatic unassignment of priorities that may otherwise be falsely interpreted due to a failure of staff to notify stakeholders of the update (e.g., utilization of a prioritized subunit).

As shown by operation 470, the prioritization apparatus 102 may include means, such as communication interface 218, processing circuitry 210, processor 212, and/or the like, for reassigning a next highest priority subunit to become the highest priority subunit. In this regard, a second or otherwise next priority subunit may be assigned the highest priority since the previous highest prioritized subunit is no longer available for incoming patients. Additional lower prioritized rooms may experience a shift in priority accordingly.

Furthermore, as shown by operation 480, the prioritization apparatus 102 may include means, such as communication interface 218, processing circuitry 210, processor 212, and/or the like, for receiving an additional indication, the additional indication indicating a higher priority subunit than at least one currently prioritized subunit. For example, as a room becomes available, a nurse or other staff may consider the newly vacated room to be the highest priority room to fill, ahead of the current highest prioritized room. A user may therefore indicate a new highest priority room, such as with a user interface of FIG. 5, for example.

As shown by operation 490, the prioritization apparatus 102 may include means, such as processing circuitry 210, processor 212, and/or the like, for in response to receiving the additional indication, reprioritizing the at least one currently prioritized subunit and prioritizing the higher priority subunit. For example, in response to the indication described with respect to operation 480, the prioritization apparatus 102 may prioritize a subunit that was not previously prioritized, shifting the priorities of the previously prioritized subunits lower or downward. As such, a user indicating a newly prioritized subunit need not change the priority of other subunits. The priorities may be updated automatically based on the newly prioritized subunit. The automatic reprioritization may improve efficiency and accuracy in scenarios in which large numbers of subunits are prioritized.

As described above, the method, apparatus, and computer program product according to some example embodiments may allow for a user, such as a nurse, to indicate the prioritization of rooms or subunits based on a current work environment of a unit (e.g., a clinical unit). Users of embodiments may change the priorities throughout the day based on changing circumstances and influences. Staff in bed management responsible for assigning incoming patients to rooms, may access the priorities for a particular unit from a remote location from the unit, providing for a more efficient room assignment process and utilization of the appropriate and/or desired rooms. Without the benefit of the method, apparatus and computer program product provided herein, a hospital or other medical facility may not have the capacity to effectively communicate within large staffs and throughout various physical areas of the hospital. An attempt to otherwise provide effective bed management may be inhibited by conflicting messages from different staff and/or departments as to the prioritization or availability of subunits. As such, embodiments may be further advantageous in high volume scenarios such as those in which bed management responds to patient admissions on behalf of several clinical units and/or particularly large clinical units within a medical facility. A centralized system for maintaining the priorities may be found to be more reliable as all stakeholders may access the same real-time data regarding the prioritization of the subunits.

FIGS. 4A and 4B illustrate operations of a method, apparatus, and computer program product according to some example embodiments. It will be understood that each operation of the flowcharts or diagrams, and combinations of operations in the flowcharts or diagrams, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory 214) storing instructions executable by a processor in the computing device (for example, by processing circuitry 210 or processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, prioritization apparatus 102, and/or client terminal 110) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, prioritization apparatus 102, client terminal 110, and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving an indication of a priority of at least one subunit in a unit, wherein the unit and subunits are defined based on a physical location;
based on the indication of the priority, assigning the priority to the subunit in a memory of an apparatus;
determining at least a current highest prioritized subunit of the unit;
causing provision of a visual indication of the current highest prioritized subunit in the unit;
receiving an indication that the at least one subunit is utilized; and
in response to receiving the indication that the at least one subunit is utilized, unassigning the priority from the subunit in the memory of the apparatus.

2. The method of claim 1, wherein causing provision of the visual indication of the current highest prioritized subunit in the unit comprises:
causing display of a geospatial arrangement comprising a visual representation of a plurality of subunits in the unit; and
causing display of the visual indication on the geo spatial arrangement and in association with the visual representation of the current highest priority subunit.

3. The method of claim 1, wherein causing provision of the visual indication of the current highest prioritized subunit in the unit comprises:
causing display of a selectable list of at least two subunits in the unit; and
causing display of the visual indication of the highest priority in association with the highest priority subunit.

4. The method of claim 1, further comprising:
reassigning a next highest priority subunit to become the highest priority subunit.

5. The method of claim 1, wherein the indication of the priority of the at least one subunit is provided via a first device and the indication to utilize the at least one subunit is provided via a second device.

6. The method of claim 1, further comprising:
receiving an additional indication, the additional indication indicating a higher priority subunit than at least one currently prioritized subunit; and
in response to receiving the additional indication, reprioritizing the at least one currently prioritized subunit and prioritizing the higher priority subunit.

7. The method of claim 1, wherein the method is performed by a prioritization apparatus configured for managing bed assignments in a medical facility.

8. A computer program product comprising at least one non-transitory computer-readable medium having computer-readable program instructions stored therein, the computer-readable program instructions comprising instructions, which when performed by an apparatus, are configured to cause the apparatus to perform at least:
receiving an indication of a priority of at least one subunit in a unit, wherein the unit and subunits are defined based on a physical location;
based on the indication of the priority, assigning the priority to the subunit in a memory of the apparatus;
determining at least a current highest prioritized subunit of the unit;
causing provision of a visual indication of the current highest prioritized subunit in the unit;
receiving an indication that the at least one subunit is utilized; and
in response to receiving the indication that the at least one subunit is utilized, unassigning the priority from the subunit in the memory of the apparatus.

9. The computer program product of claim 8, wherein causing provision of the visual indication of the current highest prioritized subunit in the unit comprises:
causing display of a geospatial arrangement comprising a visual representation of a plurality of subunits in the unit; and
causing display of the visual indication on the geospatial arrangement and in association with the visual representation of the highest priority subunit.

10. The computer program product of claim 8, wherein causing provision of the visual indication of the current highest prioritized subunit in the unit comprises:
causing display of a selectable list of at least two subunits in the unit; and
causing display of the visual indication of the highest priority in association with the highest priority subunit.

11. The computer program product of claim 8, wherein the computer-readable program instructions further comprise instructions, which when performed by an apparatus, are configured to cause the apparatus to perform at least:
reassigning a next highest priority subunit to become the highest priority subunit.

12. The computer program product of claim 8, wherein the indication of the priority of the at least one subunit is provided via a first device and the indication to utilize the at least one subunit is provided via a second device.

13. The computer program product of claim 8, wherein the computer-readable program instructions further comprise instructions, which when performed by an apparatus, are configured to cause the apparatus to perform at least:
receiving an additional indication, the additional indication indicating a higher priority subunit than at least one currently prioritized subunit; and
in response to receiving the additional indication, reprioritizing the at least one currently prioritized subunit and prioritizing the higher priority subunit.

14. An apparatus comprising processing circuitry configured to cause the apparatus to perform at least:
receiving an indication of a priority of at least one subunit in a unit, wherein the unit and subunits are defined based on a physical location;
based on the indication of the priority, assigning the priority to the subunit in a memory of the apparatus;
determining at least a current highest prioritized subunit of the unit;
causing provision of a visual indication of the current highest prioritized subunit in the unit;
receiving an indication that the at least one subunit is utilized; and
in response to receiving the indication that the at least one subunit is utilized, unassigning the priority from the subunit in the memory of the apparatus.

15. The apparatus of claim 14, wherein causing provision of the visual indication of the current highest prioritized subunit in the unit comprises:
causing display of a geospatial arrangement comprising a visual representation of a plurality of subunits in the unit; and
causing display of the visual indication on the geospatial arrangement and in association with the visual representation of the highest priority subunit.

16. The apparatus of claim 14, wherein the processing circuitry is further configured to cause at least:
causing display of a selectable list of at least two subunits in the unit; and
causing display of the visual indication of the highest priority in association with the highest priority subunit.

17. The apparatus of claim 14, wherein the processing circuitry is further configured to cause at least:
reassigning a next highest priority subunit to become the highest priority subunit.

18. The apparatus of claim 14, wherein the indication of the priority of the at least one subunit is provided via a first device and the indication to utilize the at least one subunit is provided via a second device.

19. The apparatus of claim 14, wherein the processing circuitry is further configured to cause at least:
receiving an additional indication, the additional indication indicating a higher priority subunit than at least one currently prioritized subunit; and
in response to receiving the additional indication, reprioritizing the at least one currently prioritized subunit and prioritizing the higher priority subunit.

20. The apparatus of claim 14, wherein the apparatus is a prioritization apparatus configured for managing bed assignments in a medical facility.
